(19) United States
(12) Patent Application Publication
(10) Pub. No.: US 2026/0210519 A1
(43) Pub. Date: Jul. 23, 2026

(54) LIGHTING APPARATUS FOR VEHICLES

(71) Applicant: HELLA GmbH & Co. KGaA, Lippstadt (DE)

(72) Inventors: Carsten HOHMANN, Warstein (DE); Martin MUEGGE, Geseke (DE)

(73) Assignee: HELLA GmbH & Co. KGaA, Lippstadt (DE)

(21) Appl. No.: 19/458,177

(22) Filed: Jan. 23, 2026

(30) Foreign Application Priority Data
Jan. 23, 2025 (DE) 10 2025 102 431.6

(51) Int. Cl. F21S 43/20; F21S 43/239; F21S 43/27; F21S 43/30; F21Y 115/10

(52) U.S. Cl. CPC F21S 43/26271; F21S 43/239; F21S 43/265; F21S 43/27; F21S 43/30; F21Y 2115/10

(57) ABSTRACT

A lighting apparatus for vehicles, comprising a light module which contains a housing having a flat light guide with a back flat side and a front flat side, on which coupled-in light is totally reflected, a narrow side, on which the light may be coupled into the flat light guide. A light source generates the light, the light of the light source being able to be coupled in on the narrow side, coupler for coupling out the light from the flat light guide, which emerges on the front flat side of the flat light guide. At least one micro-optical structure film is arranged in front of the front flat side of the flat light guide, with the aid of which the coupled-out light is scattered and focused. A cover panel is arranged in the light emergence direction of the flat light guide.

This nonprovisional application claims priority under 35 U.S.C. § 119(a) to German Patent Application No. 10 2025 102 431.6, which was filed in Germany on January 23, 2025, and which is herein incorporated by reference.

### BACKGROUND OF THE INVENTION

### Field of the Invention

The invention relates to a lighting apparatus for vehicles, comprising a light module which contains a housing having a flat light guide with a back flat side and front flat side, on which coupled-in light is totally reflected, a narrow side, on which the light may be coupled into the flat light guide, a light source for generating the light, the light of the light source being able to be coupled in on the narrow side, coupler for coupling out the light from the flat light guide, which emerges on the front flat side of the flat light guide, at least one micro-optical structure film or optical lens arranged at the front on the front flat side of the flat light guide, with the aid of which the coupled-out light is scattered and focused, a cover panel arranged in the light emergence direction of the flat light guide in front of the front flat side thereof and in front of the at least one micro-optical structure film or in front of the optical lens, at which the light emerges from the light module.

### Description of the Background Art

A lighting apparatus for vehicles is known from US 2006/0044825 A1, which includes two flat light guides arranged in parallel to each other. A light source is assigned to each flat light guide, whose emitted light is coupled into the flat light guide on a narrow side thereof. The generation of two different light functions is ensured thereby.

A lighting apparatus for vehicles is known from DE 10 2018 106 171 A1, which is incorporated herein by reference and which comprises a printed circuit board having a multiplicity of light sources arranged in a matrix-like manner. The light sources generate predefined illuminated graphics, depending on the activation thereof. To change the illuminated graphics, a lens cover having micro-optical elements is placed in front of the light sources arranged in a matrix-like manner. The known lighting apparatus is disadvantageous in that a relatively large number of light sources is required, and no homogeneous light illumination area is generated.

A lighting apparatus for vehicles is known from DE 10 2023 108 470 A1, which corresponds to US 2024/0328592, which is incorporated herein by reference, and which comprises a flat light guide installed in a housing together with films and a cover panel situated in front of it. A reflection film may be arranged on the back side of the flat light guide, with the aid of which light emerging from the back side of the flat light guide is reflected in the direction of a front flat side of the flat light guide for the purpose of coupling out the light in the main emission direction. The known lighting apparatus facilitates a homogeneous illumination area.

### SUMMARY OF THE INVENTION

It is therefore an object of the present invention is to provide a lighting apparatus for vehicles comprising a flat light guide in such a way that a homogeneous illuminated area is generated, an appearance of a light module including the flat light guide is able to be varied.

To achieve this object, the invention provides in an example that the cover panel can have at least one protrusion in sections and/or at least one indentation in sections, so that a front surface of the cover panel arranged in front thereof in the light emergence direction does not run in a flat manner.

An advantage of the invention is that a light module provided with a flat light guide has a sculptural appearance. A front-side outer surface of the light module does not follow a predefined curved vehicle body in a smooth-surfaced manner, but instead has a profiled appearance due to raised and/or recessed surface regions. A cover panel of the light module has a dual function. On the one hand, the cover panel is used to cover the light module or a lighting apparatus designed as a signal lamp. On the other hand, the cover panel has a raised and/or recessed front surface compared to a flat base section abutting the flat light guide, so that the light module has a three-dimensional contour on the light output side. If the cover panel is simultaneously a cover shield of the lighting apparatus, the vehicle body recess needs to have only a shallow installation depth for receiving the lighting apparatus. Only a flat base section of the cover panel runs in the elongation of the vehicle body surface, while, for example, a raised protrusion of the cover panel runs outside the elongated vehicle body surface or outside an opening cross-section of the vehicle body opening for the lighting apparatus.

The protrusions and/or an indentation of the cover panel can have a dimension in the millimeter range, preferably in the centimeter range. The protrusion or indentation of the cover panel is thus optically perceptible to an observer and gives the lighting apparatus a certain optical appearance.

The cover panel can have a flat base section, which preferably runs in parallel to the flat light guide. The dimension of the base section is equal to or smaller than the dimension of the flat light guide. The area of the base section is preferably reduced in size by the width of a fastening point between a housing frame of the housing of the light module and the base section of the cover panel, compared to the dimension of the flat light guide. In this way, the housing may advantageously comprise in a compact manner the flat light guide and the cover panel with a planar contact thereof or possibly by the parallel placement of films therebetween.

The protrusion can be provided with an elongated design. It has side surfaces raised from the base section of the cover panel and a cover surface connected to edges of the side surface. The cover surface of the cover panel thus runs outside the housing frame.

The cover surface of the protrusion and/or a part of the base section of the cover panel forming a base surface of the protrusion can have a flat and/or convex and/or concave surface. In this way, an additional optical effect may be advantageously effectuated by the refraction of penetrating light beams.

The cover surface and/or the side surface and/or the base surface of the protrusion can have micro-optical elements or an optical structure. The light guidance for generating the light function may be advantageously optimized hereby.

The side surfaces of the protrusion can be raised in the vicinity of an edge of the base section of the cover panel. In this way, the cover panel has a massive protrusion, which is raised in the main emission direction of the lighting apparatus.

The cover panel can have multiple protrusions, which may run in parallel to each other or be arbitrarily oriented in relation to each other. These protrusion may or may not have the same design. The lighting apparatus may thus have a certain contoured outer contour.

A micro-optical structure can be formed by a number of films provided in each case with micro-optical elements, which are arranged between the flat light guide and the cover panel. A uniformly homogeneous illuminated surface may be advantageous provided hereby, and the efficiency of the system may be increased.

The support for coupling out the light from the flat light guide is formed by a reflection film, which is arranged on a side of the flat light guide facing away from the cover panel, preferably placed in a housing shell of the housing. The reflection film may be made, for example, from a white plastic material, so that the light yield for generating the light function may be improved.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a side view of a light module;

FIG. 2 shows an exploded representation of the light module, including a two-part housing, a reflector film, a flat light guide, two micro-optical films, and a cover panel;

FIG. 3 shows a side representation of the cover panel having a massive protrusion;

FIG. 4 shows a side representation of the cover panel having a tapered protrusion;

FIG. 5 shows a side representation of the light module having two parallel protrusions on the cover panel;

FIG. 6 shows a side view of the cover panel having a flat cover surface of the protrusion and a concave base surface thereof; and

FIG. 7 shows a side view of the cover panel having a concave cover surface and a convex base surface.

### DETAILED DESCRIPTION

A light module 1 according to the invention may be mounted as a lighting apparatus in a vehicle body opening of a vehicle back side, which is not illustrated, to form a tail lamp.

Light module 1 has a housing 2, which is essentially used to receive a flat light guide 3 and a cover panel 4 covering the latter. Housing 2 has a housing shell 5 and a housing frame 6, which are preferably connected to each other by a latching connection.

Housing shell 5 has a base 7 and edge surfaces 8, which protrude therefrom at least on three sides and are designed in such a way that they surround flat light guide 3. Housing frame 6 has a profiling 9, such that it is connected to a holding web 10 of cover panel 4 in a form-fitting and/or force-fitting manner.

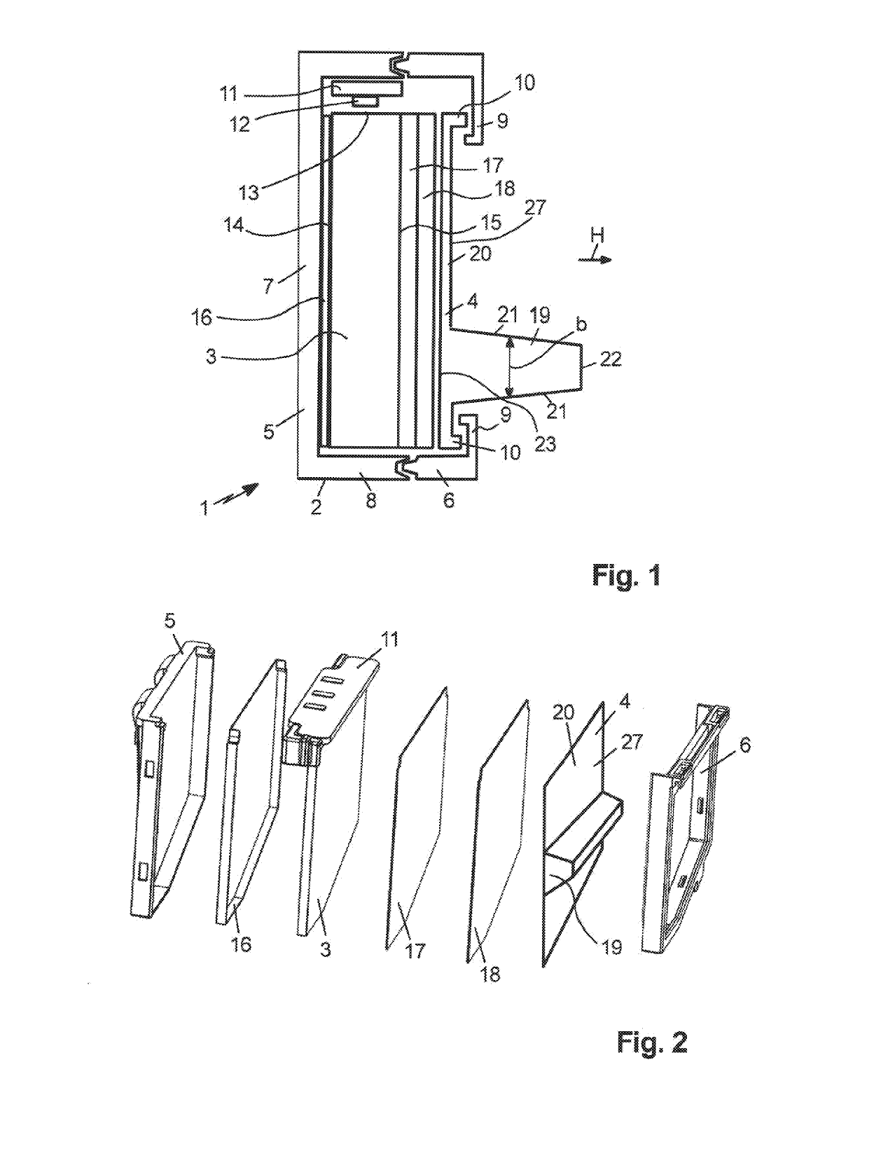

As is apparent from FIG. 2, a printed circuit board 11 is arranged on an edge side of flat light guide 3, which is fitted with a number of light sources 12 arranged in a row. Light sources 12 extend along a narrow side 13 of flat light guide 3, which is used as a light coupling-in surface.

Flat light guide 3 has parallel flat sides 14, 15, which abut light coupling-in narrow side 13, a back flat side 14 extending on a side facing housing shell 5 of housing 2, and a front flat side 15 extending on a side of flat light guide 3 facing away from housing shell 5. The further narrow sides of flat light guide 3 are preferably covered by housing shell 5.

For example, coupling-out elements, which are not illustrated, on which the coupled-in light is refracted or reflected in main emission direction H, may be arranged on back flat side 14 or on front flat side 15 as a coupler for coupling out the light from flat light guide 3.

In the example, a reflection film 16 is arranged between flat light guide 3 and base 7 of housing shell 5, with the aid of which light emerging from back flat side 14 of flat light guide 3 is reflected in the direction of flat light guide 3 and passes through the latter, so that it emerges from flat light guide 3 in main emission direction H. Reflection film 16 may be arranged directly on or at a distance from back flat side 14 of flat light guide 3.

In example, it is assumed that a first portion of the light coupled into flat light guide 3 is totally reflected on back flat side 14 and on front flat side 15 of flat light guide 3 until it strikes back flat side 14 and/or front flat side 15 of flat light guide 3 at such a steep angle that it emerges on front flat side 15 of flat light guide 3 in main emission direction H. When a second portion of the light emerges from flat light guide 3 on back flat side 14, the light is reflected back in the direction of back flat side 14 with the aid of reflection film 16, so that it enters flat light guide 3 again on back flat side 14 and then emerges from flat light guide 3 in main emission direction H on front flat side 15 thereof directly and/or after a further total reflection on back flat side 14 and/or on front flat side 15 of flat light guide 3. A luminous flux of the second portion of the coupled-in light is smaller than a luminous flux of the first portion of the coupled-in light. Reflection film 16 is thus used as a support for coupling out the light. The primary way for coupling out the light is formed by back flat side 14 and front flat side 15 of flat light guide 3, which preferably run in parallel. Reflection film 16 is used as a further coupler for coupling out light.

According to an example of the invention, which is not illustrated, base 7 of housing shell 5 may be provided with a reflective or mirroring coating to reflect the light emerging on back flat side 14 of flat light guide 3 back in the direction of flat light guide 3.

In the present example, two micro-optical structure films, referred to below as micro-optical films 17, 18, are arranged between flat light guide 3 and cover panel 4, which each have micro-optical elements. The emerging light may be homogenized by the micro-optical elements of micro-optical films 17, 18, so that the light is emitted homogeneously, similarly to the use of OLED light sources. In the present example, an LED light source is used as the light source. Micro-optical films 17, 18 preferably each have the micro-optical elements on a front side facing away from flat light guide 3. Micro-optical films 17, 18 are designed to be smooth on a back side facing flat light guide 3.

According to an example, which is not illustrated, a different number of micro-optical films 17 may also be provided, for example, only a single micro-optical film 17.

According to an example, which is not illustrated, an optical lens may be arranged between flat light guide 3 and the optical cover pane 4 instead of the at least one micro-optical film 17.

According to an example of the invention, multiple elevations are provided on front flat side 15 of flat light guide 3 as spacer lugs with respect to a smooth back side of micro-optical film 17 arranged on front flat side 15. The spacer lugs may be arranged in a centimeter range in relation to each other, i.e., adjacent spacer lugs have a distance from each other of some centimeters. This prevents the smooth back side of micro-optical film 17 from adhering or sticking to front flat side 15, which is perceived as a distracting spot in the light distribution (wet effect).

Cover panel 4 according to the invention does not have two planar flat sides, as does flat light guide 3. Instead, cover panel 4 may have at least one protrusion 19 in sections and/or at least one indentation in sections, which is not illustrated. Protrusion 19 is designed to be raised over a vehicle body edge surrounding, while the indentation in the vehicle body opening receiving the light module is designed to project inwardly.

As is apparent from FIG. 1, protrusion 19 is connected to form a single piece with a base section 20 of cover panel 4. Base section 20 of cover panel 4 has holding web 10 on the edge side for connection to housing frame 6 or housing 2. This results in a non-planar course of a front surface of cover panel 4 or light module 1 arranged on the front.

Base section 20 of cover panel 4 has a flat light entry surface, which faces flat light guide 3. Protrusion 19 extends from base section 20 in main emission direction H. Protrusion 19 is designed to be elongated and may extend, for example, from a side end of light module 1 to an opposing side end thereof. Protrusion 19 has opposing side surfaces 21 which are raised from base section 20 of cover panel 4. Protrusion 19 also has a cover surface 22 connected to edges of side surfaces 21. At least opposing side surfaces 21 preferably run in the direction of cover surface 22 in a tapering manner. On the back side, protrusion 19 transitions into base section 20, a part of base section 20 forming a base surface 23 of protrusion 19 in the elongation of side surfaces 21.

For example, cover surface 22 of protrusion 19 may be designed to be flat and base surface 23 to be concave; cf. FIG. 6.

For example, cover surface 22 of protrusion 19 may be designed to be concave and base surface 23 thereof to be convex; cf. FIG. 7.

Depending on the optical appearance, base surface 23, on the one hand, an cover surface 22 of protrusion 19, on the other hand, may thus be designed to be flat and/or convex and/or concave.

According to an example of the invention, which is not illustrated, cover surface 22 and/or side surface 21 and/or base surface 23 of protrusion 19 is/are provided with micro-optical elements or with an optical structure. The optical structure may be produced, for example, by etching or by erosion or by a laser. This results in a further, changed optical character of the light module.

Protrusion 19 may have a dimension in the centimeter range. This means that a distance b, which represents a width of protrusion 19, may be in the range of just a few centimeters. Width b of protrusion 19 may be, for example, in the range between 0.5 cm and 10 cm. This assumes that side surfaces 21 of cover panel 4 are designed to be relatively steep. If side surfaces 21 have an angle with respect to main emission direction H in the range from 10° to 20°, the middle width may be used as width b, opposing side surfaces 21 extending in a middle region, i.e., in a middle region between cover surface 22 and base surface 23.

Identical components or component functions are provided with the same reference numerals.

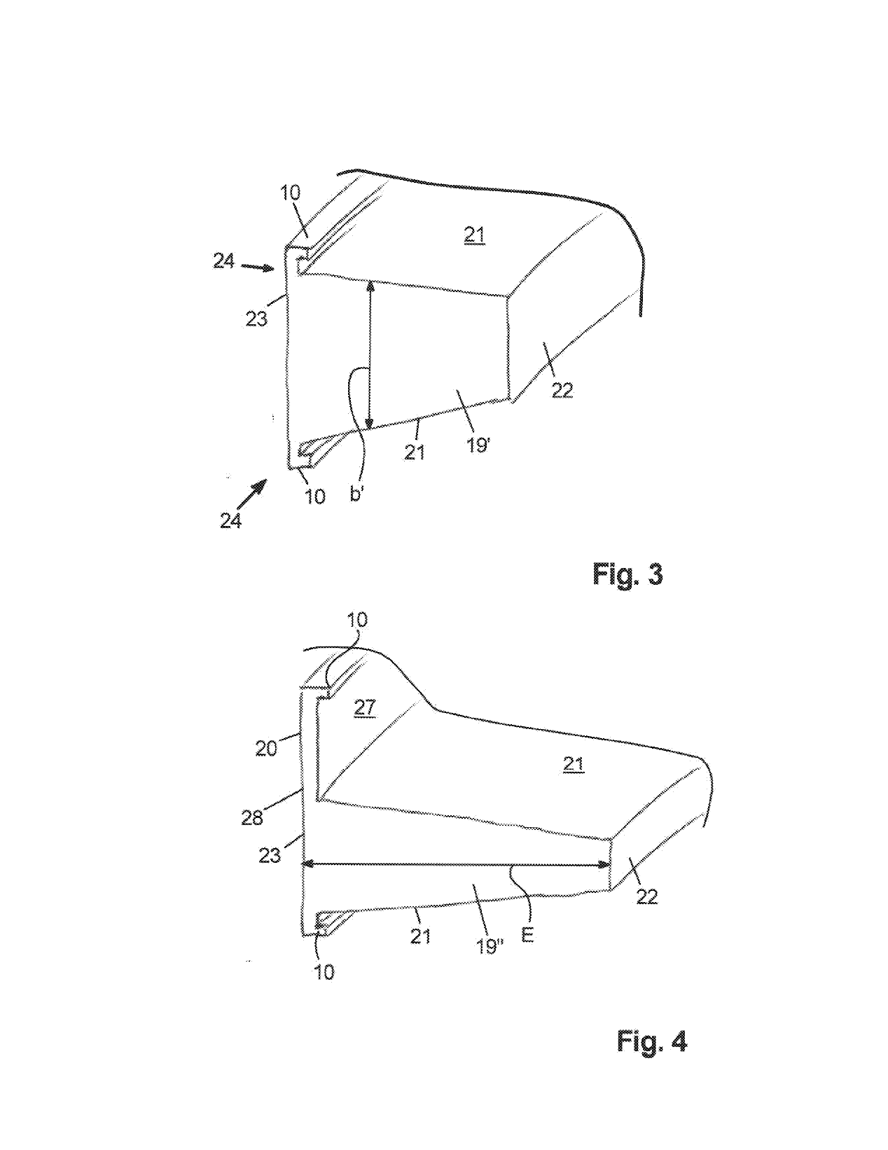

According to one design of light module 1 according to FIG. 3, a protrusion 19’ is provided, whose opposing side surfaces 21 rest on an edge 24 of base section 20. A foot-side width of protrusion 19’ essentially corresponds to the opening cross-section formed by housing frame 6 for the emergence of light. A middle width b’ of protrusion 19’ is thus in a range between 3 cm and 10 cm. Middle width b’ is defined by the width of protrusion 19’ in the middle of opposing side surfaces 21 between base section 20 and cover surface 22.

According to an example of the invention according to FIG. 4, a protrusion 19’’ is provided, which is designed to taper to point and have a relatively large elevation E. Elevation E corresponds to the distance between cover surface 22 of protrusion 19’ and base section 20 of cover panel 4 or base surface 23 of protrusion 19’’.

Cover surface 22 has a much smaller area than base surface 23. The area of cover surface 22 may be, for example, smaller than 50% of base surface 23 of protrusion 19’.

Cover surface 22 of protrusions 19 and 19’ have an area which is larger than 50% of base surface 23 of same protrusions 19. 19’.

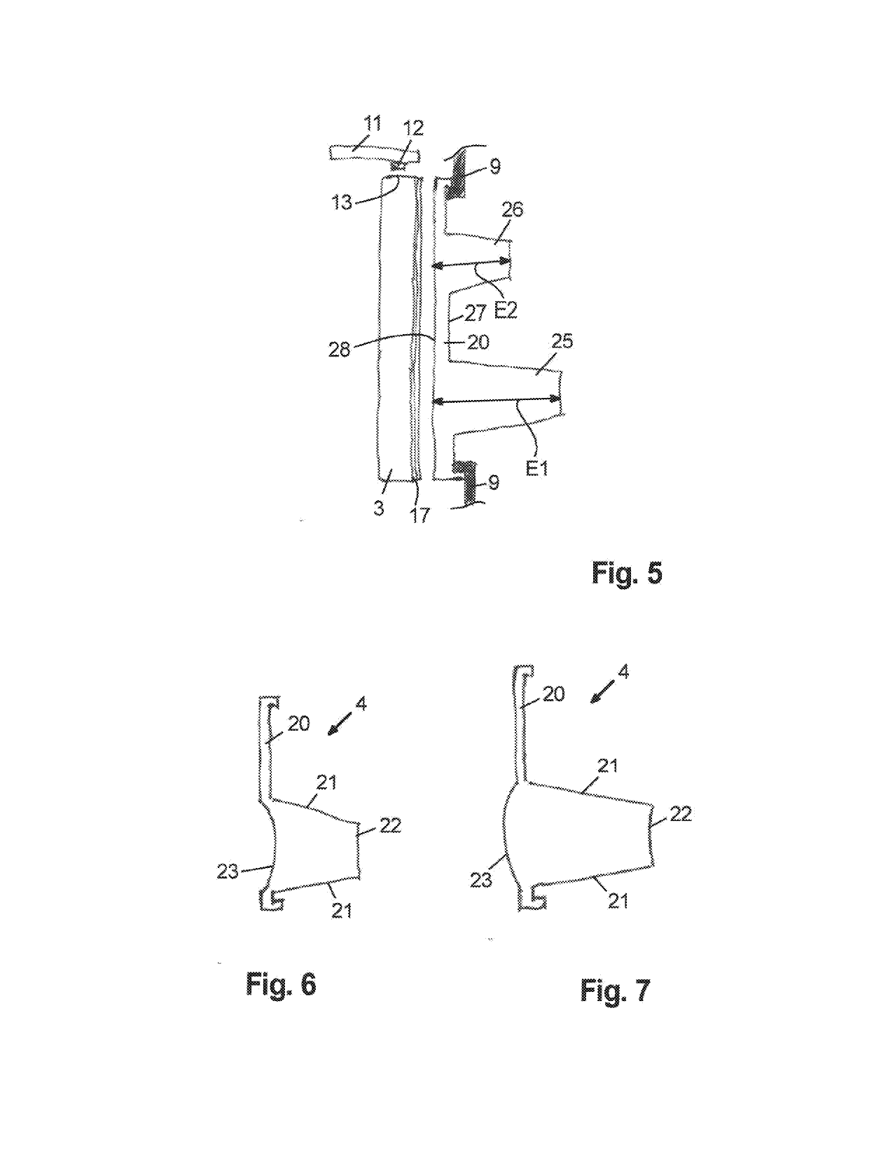

According to an example of the invention according to FIG. 5, two protrusions 25 and 26 arranged adjacent to each other may be raised from base surface 20 of cover panel 4. The one protrusion 25 has a larger elevation E1 than an elevation E2 of second protrusion 26.

Cover panel 4 thus always has a larger light outlet surface than does flat light guide 3. It is assumed that light is coupled out not only on cover surface 22 of protrusion 19, 19’, but also on a front surface 27 of base section 20 as well as on opposing side surfaces 21.

Front surface 27 of base section 20 preferably runs in parallel to a back surface 28 of base section 20 provided for the light inlet.

It should be noted that light module 1 may be used to generate, for example, a tail or brake light function and/or a blinker function. Depending on the light function, LED light sources of different color emission may be provided, namely red, yellow, or white. Depending on the activation of the LED light sources emitting different light colors, a tail light function or a brake light function or a cornering light function or a backup light function may be generated.

If light module 1 according to the invention is not installed in a shared housing 2 combined with further light modules, but if light module 1 is to be installed as a single light module in a vehicle body opening, cover panel 4 is simultaneously used as a cover shield for the lighting apparatus, base section 20 of cover panel 4 extending in an edge-side elongation of the edge of the vehicle body opening.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A lighting apparatus for vehicles, the lighting apparatus comprising:
a light module having a housing;
a flat light guide has a back flat side and a front flat side, coupled-in light is substantially reflected in the flat light guide;
a narrow side, on which light is adapted to be coupled into the flat light guide;
a light source to generate the light, the light of the light source being adapted to be coupled in on the narrow side;
coupler to couple out the light from the flat light guide, which emerges on the front flat side of the flat light guide;
at least one micro-optical structure film or optical lens arranged at a front on the front flat side of the flat light guide, with the aid of which the coupled-out light is scattered and focused;
a cover panel, which, in a light emission direction of the flat light guide, is arranged in front of the front flat side thereof and in front of the at least one micro-optical structure film or the at least one optical lens, and at which the light emerges from the light module, the cover panel having at least one protrusion in sections and/or at least one indentation in sections, so that a front surface of the cover panel arranged at the front in the light emergence direction does not run in a flat manner.

2. The lighting apparatus according to claim 1, wherein the protrusion and/or the indentation have a dimension at least in the millimeter range, or in the centimeter range.

3. The lighting apparatus according to claim 1, wherein the cover panel has a flat base section on which the protrusion and/or the indentation are formed, and wherein the base section runs substantially in parallel to the flat light guide, a dimension of the base section corresponding to a dimension of the flat light guide.

4. The lighting apparatus according to claim 1, wherein the base section of the cover panel has a holding web on at least one edge side for fastening to the housing frame, and/or wherein the housing frame has a profiling for fastening the latter to the flat light guide and/or the base section of the cover panel.

5. The lighting apparatus according to claim 1, wherein the protrusion is designed to be elongated, with opposing side surfaces raised from the base section and with a cover surface connecting edges of the side surfaces.

6. The lighting apparatus according to claim 1, wherein the cover surface of the protrusion and/or a part of the base section forming a base surface of the protrusion is designed to be flat and/or convex and/or concave.

7. The lighting apparatus according to claim 1, wherein the cover surface and/or the side surface and/or the base surface of the protrusion is/are provided with micro-optical elements or with an optical structure, the optical structure being produced by etching or erosion or by lasers.

8. The lighting apparatus according to claim 1, wherein the side surface of the protrusion is raised from an edge of the base section in the vicinity thereof.

9. The lighting apparatus according to claim 1, wherein the cover panel has multiple protrusions.

10. The lighting apparatus according to claim 1, wherein multiple elevations are provided on the front flat side of the flat light guide as spacer lugs with respect to a smooth back side of the micro-optical structure film or optical lens arranged on the front flat side.

11. The lighting apparatus according to claim 1, wherein the micro-optical structure films or the optical lens are arranged between the flat light guide and the cover panel.

12. The lighting apparatus according to claim 1, wherein a reflection film is provided as the coupler for coupling out the light from the flat light guide, which is arranged on a side of the flat light guide facing away from the cover panel and supports the coupling out of the light from the flat light guide.

13. The lighting apparatus according to claim 12, wherein the reflection film is arranged such that it is placed in a housing shell of the housing.

14. The lighting apparatus according to claim 1, wherein the housing shell is formed in a mirrored manner on a surface facing the flat light guide.

15. The lighting apparatus according to claim 1, wherein the housing has a housing frame connected to the housing shell, which engages around the edges of the flat light guide and/or the cover panel.
